(19) United States
(12) Patent Application Publication
(10) Pub. No.: US 2008/0014923 A1
(43) Pub. Date: Jan. 17, 2008

(54) PORTABLE MOBILE TERMINAL

(75) Inventors: HEINRICH ESSER, Wedemark (DE); Wolfgang Niehoff, Wedemark (DE)

Correspondence Address: Gerald H. Kiel, Esq.;REED SMITH LLP, 599 Lexington Avenue, New York, NY, 10022-7650, US

(73) Assignee: Sennheiser electronic GmbH & Co. KG

(21) Appl. No.: 11/777,432

(22) Filed: Jul. 13, 2007

(30) Foreign Application Priority Data
Jul. 14, 2006 (DE) 10 2006 032 822.1

(51) Int. Cl. H04Q 7/20

(52) U.S. Cl. 455/425

(57) ABSTRACT

The invention is directed to a portable mobile terminal having a wireless receiver (DE) for receiving wirelessly transmitted audio signals of a microphone (DM). The wireless receiver (DE) has a plurality of antennae, and the reception is based on a receiver diversity.

### CROSS-REFERENCE TO RELATED APPLICATION

This application claims priority of German Application No. 10 2006 032 822.1, filed Jul. 14, 2006, the complete disclosure of which is hereby incorporated by reference.

### a) FIELD OF THE INVENTION

The present invention is directed to a portable mobile terminal. Portable mobile terminals of this kind can be, for example, notebooks, PDAs, Smart Phones, mobile telephones, or the like.

### b) DESCRIPTION OF THE RELATED ART

Wireless microphone systems are typically proprietary solutions. The wireless microphones have a transmitter for sending the transmitted audio signals wirelessly. Also provided in the wireless microphone systems is a wireless receiver which receives the wirelessly transmitted signals of the microphone and, as the case may be, sends them to an external device.

In wireless microphone systems of the type mentioned above, VHF and UHF television frequency bands, for example, are used for wireless transmission. However, an operating license that can be issued by the local frequency allocation authorities is required for this purpose. Such operating licenses can be issued only to a restricted extent such as, for example, to radio stations, theaters, event centers, or the like.

Therefore, non-commercial or private users must often work with the ISM frequency bands because no operating license is required in this case. However, this has the disadvantage that several wireless transmission systems may interfere with one another within a local region.

EP 1 455 487 A1 shows a notebook or a laptop and a wireless headset. Communication between the notebook and the wireless headset is carried out based on the Bluetooth protocol. The audio signals picked up by the microphone of the wireless headset are transmitted wirelessly and directly to the notebook.

### OBJECT AND SUMMARY OF THE INVENTION

Accordingly, it is the primary object of the present invention to provide a portable mobile terminal which enables a reliable and high-quality reception of wireless signals of a microphone.

This object is met by a portable mobile terminal in accordance with the invention, comprising a wireless receiver for receiving wirelessly transmitted audio signals of a wireless microphone. The wireless receiver is connected to the mobile terminal by a first interface and has a plurality of antennae and reception is based on a receiver diversity. The portable mobile terminal also comprises an audio processing unit for processing the wirelessly transmitted audio signals and for controlling a loudspeaker system and/or a light control system which can be connected to the mobile terminal by a second interface. The audio processing unit is designed to control the reproduction of the loudspeaker system and/or of the light control system.

Accordingly, a portable mobile terminal is provided which has a wireless receiver for receiving wirelessly transmitted audio signals of a microphone. The wireless receiver has a plurality of antennae, and the reception is based on a receiver diversity.

According to one aspect of the present invention, the portable mobile terminal has a remote control reception unit for receiving and evaluating remote control signals which are transmitted wirelessly by a wireless microphone.

The invention is likewise directed to a wireless receiver for receiving wirelessly transmitted audio signals from a wireless microphone. The receiver has a standard interface by means of which the receiver can be connected to a mobile terminal. The wireless receiver has a plurality of antennae, and the reception is based on a reception diversity.

The embodiment examples and advantages of the present invention are described more fully with reference to the drawings.

### BRIEF DESCRIPTION OF THE DRAWINGS

In the drawings:

FIG. 1 shows a schematic block wiring diagram of the wireless microphone system according to a first embodiment example; and

FIG. 2 shows a schematic block wiring diagram of a mobile terminal according to a second embodiment example.

### DESCRIPTION OF THE PREFERRED EMBODIMENTS

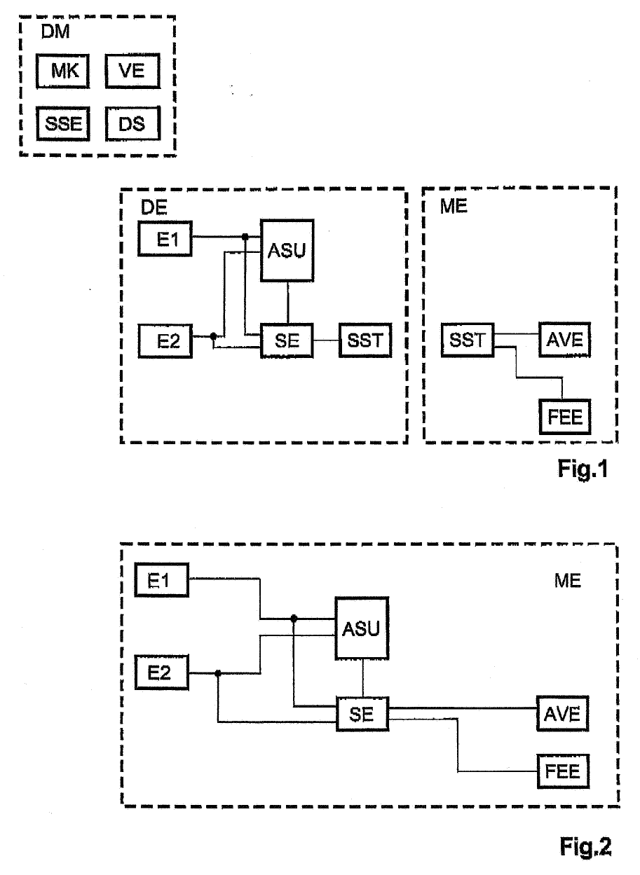

FIG. 1 shows a block wiring diagram of a wireless microphone system according to a first embodiment example. The wireless microphone system has a wireless microphone DM, a mobile terminal ME, and a wireless receiver DE. A microphone cartridge MK for recording audio signals, a processing unit VE for processing the audio signals recorded by the microphone cartridge MK, and a wireless transmitter DS for sending the recorded audio signals wirelessly are arranged in the wireless microphone DM.

The mobile terminal ME is connected to an external wireless receiver DE by a standard interface SST.

The external wireless receiver DE preferably has a plurality of antennae to enable reception diversity. The wireless receiver DE accordingly has at least two receivers E1 and E2 which are connected to an evaluating and controlling unit ASU. The wireless receiver DE also has a switching unit SE to select the receiver that delivers the best signal based on the evaluation of the first and second receivers E1, E2.

So-called “smart antennae” which are designed as an array of four or more antennae can be used alternatively or in addition. The signals of the individual antennae are combined by adjustable phase shifters.

FIG. 2 shows a block wiring diagram of a mobile terminal according to a second embodiment example. In the mobile terminal according to the second embodiment example, the wireless receiver is not designed as an external unit but rather is integrated in the mobile terminal. The construction of the wireless receiver DE according to the second embodiment example corresponds to the construction of the wireless receiver according to the first embodiment example. However, the standard interface SST can be dispensed with in this case.

The wireless receiver according to the first and second embodiment examples can be used, for example, in the VHF and UHF frequency ranges or in the ISM frequency range. Alternatively, the reception of the wireless receiver can also be based on a Bluetooth protocol, a WLAN protocol, or a high-frequency protocol.

The standard interface SST can be implemented, for example, as a USB interface. The external wireless receiver can be supplied with the appropriate operating voltage via the standard interface SST. Alternatively, the interface SST can also be implemented as a wireless interface based on the Bluetooth protocol or WLAN protocol.

The mobile terminal ME can be implemented, for example, as a laptop or notebook, a PDA, a Smart Phone, a mobile telephone, or the like. The mobile terminal can realize determined functions which are needed for further processing of or for the reception of the wirelessly transmitted audio signals. Examples of such functions include decompression in a compander system, de-emphasis, influencing of frequency response, a mute function, and a diversity function on the digital plane. Further, the mobile terminal can control loudness and can carry out audio processing of the received audio signal. This can be, for example, a mixing of a plurality of signal sources or a level adjustment of individual signal sources so that, for example, a mixing console function can be realized.

The digital audio processing can preferably have all of the digital algorithms for audio processing. The digital audio signal processing can also have a function which prevents or reduces feedback in the event such feedback occurs.

Further, the wireless receiver can also be designed to scan the available frequency range to find free frequencies for a wireless audio transmission. As soon as the wireless receiver has found a corresponding free frequency, the wireless microphone can be alerted so that the wireless microphone can then send on this free frequency.

In case the mobile terminal has, for example, a Bluetooth or WLAN interface, the wireless audio transmission can take place via Bluetooth or WLAN. The computer capacity available in the mobile terminal can be used for decoding and preparing the audio signals so that no external, separate wireless receiver is necessary.

The wireless microphone DM can also (optionally) have a control unit SSE which can be used to control the wireless receiver DE and/or the mobile terminal ME. Accordingly, a remote control function can be implemented for the mobile terminal by means of this control unit SSE, the wireless microphone functioning as a remote control. In this case, the remote control signals are sent from the wireless microphone DM to the wireless receiver DE which in turn conveys the received signals to the mobile terminal ME. A remote control reception unit FEE can be implemented in the mobile terminal. This remote control reception unit FEE analyzes the remote control commands transmitted by the wireless microphone and controls the mobile terminal in a corresponding manner. This opens up the possibility for a presenter to give a presentation by means of the mobile terminal without requiring an additional external device.

In addition or alternatively, the mobile terminal can be designed to communicate wirelessly with loudspeakers, loudspeaker systems, light control systems or PA systems. This communication can be carried out, for example, on a Bluetooth protocol, WLAN protocol, or the like. Accordingly, when a presentation is to be given, the level of the individual signal sources need only be adjusted to the mobile terminal and the microphone switched on. A presenter is accordingly free to give a presentation by means of the remote control function of the wireless microphone described above and need not have to resort to the mobile terminal.

The data and programs required for the reception of a wireless microphone can be stored, for example, on a mobile external data carrier such as, e.g., a CD, a USB stick or, alternatively, on a server on the Internet so that it is easily possible to adapt the mobile terminal to the respective wireless microphone.

The digital audio signal processing is preferably carried out in the mobile terminal as a software application. Optionally, a feedback suppression system can be provided to prevent any feedback. Further, room acoustics can be monitored automatically (for example, by means of the wireless microphone and/or a microphone in a laptop, for example). The detected room acoustics parameters can then be taken into account correspondingly in the digital audio signal processing.

When the mobile terminal is designed as a notebook, for example, a window can be provided for correspondingly changing the functions of the wireless microphone, wireless receiver and acoustic properties of an audio reproduction device. For example, this can be a matter of influencing the volume level. This window should preferably always be arranged in the foreground so that the mobile terminal can be accessed quickly and reliably.

While the foregoing description and drawings represent the present invention, it will be obvious to those skilled in the art that various changes may be made therein without departing from the true spirit and scope of the present invention.

What is claimed is:

1. A portable mobile terminal comprising:
a wireless receiver for receiving wirelessly transmitted audio signals of a wireless microphone;
said wireless receiver being connected to the mobile terminal by a first interface and having a plurality of antennae and reception being based on a receiver diversity; and
an audio processing unit for processing the wirelessly transmitted audio signals and for controlling a loudspeaker system and/or a light control system which can be connected to the mobile terminal by a second interface;
said audio processing unit being designed to control the reproduction of the loudspeaker system and/or of the light control system.

2. The portable mobile terminal according to claim 1, also with a remote control reception unit for receiving and evaluating remote control signals that are transmitted wirelessly by a wireless microphone.

3. The portable mobile terminal according to claim 1, wherein the wireless receiver is also designed to scan the available frequency range to find free frequencies for a wireless audio transmission.

4. The portable mobile terminal according to claim 1, also having room acoustics control unit for monitoring the audio signals of the wireless microphone and for receiving room acoustics parameters based on the received audio signals of the wireless microphone, wherein the audio processing unit is designed to control the reproduction of the loudspeaker system depending on the detected room acoustics parameters.

5. A wireless microphone system comprising a portable mobile terminal according to claim 1.
